(19) United States
(12) Patent Application Publication
(10) Pub. No.: US 2025/0044027 A1
(43) Pub. Date: Feb. 6, 2025

(54) RECOVERY DEVICE

(71) Applicant: Mathias KLEINE, Wetter (DE)

(72) Inventor: Mathias KLEINE, Wetter (DE)

(21) Appl. No.: 18/720,552

(22) PCT Filed: Dec. 14, 2022
(86) PCT No.: PCT/EP2022/085865

§ 371 Date: Jun. 14, 2024

(30) Foreign Application Priority Data
Dec. 15, 2021 (EP) 21214691.4

(51) Int. Cl. F26B 23/00; F26B 25/00

(52) U.S. Cl. CPC F26B 23/002; F26B 25/005

(57) ABSTRACT

The invention relates to a recovery device and a recovery method for recovering heat from moist exhaust air containing particles, having a housing extending in a flow direction of moist exhaust air containing particles from an entrance to an exit, a plurality of tube elements extending parallel to one another within the housing and a heat exchange medium for absorbing heat from the moist exhaust air containing particles. In order to provide a device and a method which enable energy to be recovered from the exhaust air of industrial heat generators and, in particular, of industrial drying systems with a long, uninterrupted operating time and with little downtime, it is provided that the moist exhaust air is conducted through the interior of the tube elements and the heat exchange medium flows around the exterior of the tube elements, and a cleaning unit (14) for cleaning the interior of the tube elements is arranged upstream of the tube elements (10) in the direction of flow (SR) of the moist exhaust air containing particles.

The invention relates to a recovery device and a recovery method for industrial heat generators and in particular for industrial drying systems for recovering beat from moist, exhaust air containing particles and in particular fibers, for example for laundries.

Recovery devices and methods are generally known from the state of the art in a variety of designs and have already been used on an experimental basis in commercial laundries to recover energy from fiber-containing, moist and, in particular, water vapor-saturated exhaust air, which is produced, for example, during the drying of drying material, in particular textiles, in industrial drying systems.

In the devices and methods of the prior art, this is done by a heat exchanger, in particular a finned heat exchanger. The moist exhaust air is passed through the heat exchanger and in particular over the outside of the fins, wherein condensate is produced. During drying the drying material, the exhaust air is enriched with fibers, which are deposited in the heat exchanger, resulting in a significant reduction in the efficiency of the heat recovery and a decrease in the functionality of the heat exchanger and ultimately to a complete clogging of the heat exchanger.

The disadvantage of these prior art devices and associated methods is therefore that permanent, low-maintenance or even maintenance-free operation is not possible. Accordingly, this results in high maintenance and repair costs as well as frequent operational failures of the heat exchanger, for example in the area of an exhaust air outlet of industrial or commercial drying systems, which also leads to malfunctions and operational interruptions in these systems or, in the worst case, even damage to the drying systems upstream of the recovery device.

The invention is therefore based on the object of providing a device and a method which enable energy to be recovered from the moist exhaust air containing particles from industrial heat generators and, in particular, for industrial drying systems with a long, uninterrupted operating time.

According to the invention, the object is solved by a recovery device according to claim 1 and a recovery method according to claim 9. Advantageous further embodiments of the invention are given in the dependent claims.

The recovery device according to the invention for recovering heat from exhaust air containing particles and in particular fibers has a housing from an entrance to an exit extending in a flow direction of the moist exhaust air containing particles, a plurality of tube elements extending within the housing, preferably parallel to a longitudinal axis of the housing and/or parallel to one another, and a heat exchange medium for absorbing beat from the moist exhaust air containing particles, wherein the moist exhaust air containing particles is directed through the interior of the tube elements and the heat exchange medium flows around the exterior of the tube elements. In addition, according to the invention, a cleaning unit arranged upstream of the tube elements in the direction of flow of the moist exhaust air containing particles is provided for cleaning the interior of the tube element.

The inventor has recognized that the arrangement of a cleaning unit upstream of the tube elements has numerous advantages and in particular makes it possible to recover the energy of the moist and warm exhaust air of an industrial heat generator and in particular of an industrial drying system for a commercial laundry, whereby deposits of particles and in particular fibers in the tube elements are significantly reduced by the additional cleaning by means of the cleaning unit. The risk of malfunctions and failures of the recovery device due to particle deposits can thus be greatly reduced, which leads directly to a longer uninterrupted operating time, to cost savings and to significantly reduced maintenance work.

The inventor has also recognized that a particularly efficient energy recovery from particle-containing, moist air is possible by means of a heat exchanger formed as a tube bundle heat exchanger, in particular since such a tube bundle heat exchanger with a guidance of the particle-containing, moist exhaust air within the tubes enables effective cleaning by means of a cleaning unit according to the invention, whereas, for example, a finned heat exchanger in connection with exhaust air containing particles can hardly be kept sufficiently clean and passible in the long term.

A recovery device is generally understood to be a structural unit that is provided for recovering a substance and/or resource that has been supplied. Preferably, the recovery device recovers at least one substance and/or one resource from a mixture of different substances and/or resources. An example of a substance to be recovered is water, in particular as condensate from moist exhaust air or another moist gas or gas mixture. The recovered resource can be only heat or also another resource. Preferably, the recovery device is primarily intended for heat recovery and, particularly preferably, condensed water is also recovered.

In principle, the recovery device can be arranged at any location and at any distance from the industrial heat generator or the industrial drying system. For example, the recovery device can be arranged in a working plane formed, for example, by a wall, ceiling or roof of a building. For this purpose, the housing can, for example, have support elements for locking the housing in the plane of use. Preferably, the recovery device is arranged on a roof and/or directly in the area of an outlet of the industrial heat generator or the industrial drying system. For example, holding elements are provided on the housing for transporting and/or handling the recovery device.

An industrial heat generator can initially be any system that generates heat and emits at least part of the heat in a gas flow, in particular as part of an exhaust air flow. Examples of such industrial heat generators are drying systems and ovens, such as industrial baking ovens or ovens in the food industry. However, the heat generator can also be used in another branch of industry, such as textile production or treatment. What all industrial heat generators have in common, however, is that they emit an exhaust air flow that contains particles and moisture, preferably water vapor or high humidity.

The industrial drying system, for which the recovery device is preferably used, can in principle be any system for removing water, aqueous solutions and/or cleaning agents from objects, the drying system preferably being intended for drying textiles and particularly preferably for drying laundry. In this context, the drying system is particularly preferably part of a laundry and very particularly preferably arranged on one or more industrial laundry dryers. It can also be used in conjunction with a large drying appliance, such as those used in hotels. In this context, an industrial drying system is understood to be a system which is intended for use in the commercial, professional and/or industrial sector for drying moist items, in particular moist textiles and/or moist laundry.

According to the invention, the exhaust air supplied to the recovery device comprises particles, wherein the particles can be any solids contained in the exhaust air. Preferably, the particles are smaller than 5 mm and/or have a mass of less than 1 g. For example, the particles can be formed from small pieces of baked goods and/or flour. In principle, however, particles made of any material are conceivable, but preferably hydrophilic. It is also preferred that at least some of the particles are fibers, and it is particularly preferred that the particles are predominantly fibers and very particularly preferred that they are essentially exclusively fibers, whereby fibers are generally understood to mean any particles that are produced or can be detached from the textile during the treatment of textiles and laundry, in particular during washing, smoothing and/or drying. In addition, the exhaust air may also contain other particles, for example foreign bodies and/or components of a cleaning agent or other auxiliary material that are introduced together with the textiles.

In addition to particles, the exhaust air contains a proportion of a liquid, so that the exhaust air is described as moist. This can be any liquid, whereby the liquid in the exhaust air is preferably present completely as a gas or vaporized. Particularly preferably, the moist contained in the exhaust air is a vaporized aqueous solution and especially preferably essentially pure water and possibly unavoidable small amounts of other substances, such as components of a detergent and/or a fabric softener.

The housing is used to guide the moist exhaust air from the entrance to the exit and/or to shield the inside of the recovery device from the environment and/or to prevent an uncontrolled exit of supplied exhaust air. For this purpose, the housing is preferably tubular. The housing preferably has a polygon-shaped, elliptical or particularly preferably circular cross-section extending along the longitudinal axis of the housing between the entrance and the exit.

Each of the tube elements is arranged in the direction of flow of the moist exhaust air containing particles between the entrance and the exit of the housing. Furthermore, the tube element preferably has a polygon-shaped, elliptical or particularly preferably circular cross-section extending along a longitudinal axis of the tube element. The diameter of a tube element is preferably a maximum of 50%, particularly preferably a maximum of 25%, especially preferably a maximum of 15% and particularly preferably a maximum of 10% of a diameter of the housing, especially in the area of the tube elements.

The recovery device is preferably designed to be able to pass an exhaust air volume flow of at least 1000 l/h. In general, the recovery device is preferably designed and in particular dimensioned in such a way that a significant increase in pressure in the area of the entrance compared to the ambient pressure is avoided, as industrial heat generators and in particular industrial drying systems are typically not designed to build up an increased pressure, but should generate the largest possible volume flow, so that a back pressure in the area of the recovery device would disrupt the operation of the heat generator or the drying system. Accordingly, the recovery device is preferably designed to be able to pass a volume flow of at least 7000 l/h, particularly preferably at least 8000 l/h and very particularly preferably 9000 l/h.

The longitudinal axis of the tube element can, for example, be arranged parallel to or in the longitudinal axis of the housing. Furthermore, the tube element is formed in such a way that the moist exhaust air containing particles flows within the tube element in the direction of the exit of the housing. For example, the tube element is formed as a tube with a constant diameter. Preferably, the housing and/or the tube element are made of a metallic material, in particular a steel or aluminum material.

The heat exchange medium basically serves to absorb heat from the moist exhaust air and/or to dissipate the absorbed heat from the recovery device, in particular to another heat exchanger. For this purpose, the beat exchange medium preferably has a lower temperature than the moist exhaust air containing particles, at least when it is fed to the recovery device, so that the heat from the exhaust air is transferred to the heat exchange medium due to the temperature difference and/or can be transferred by convection. Although it is conceivable in principle to continuously supply the recovery device with new heat exchange medium, for example when used to directly heat water, in particular laundry water, it is preferable for the heat exchange medium to be circulated, in particular in a closed circuit.

Preferably, the recovery device and, in particular, the housing and the tube element are formed in such a way that the heat exchange medium at least partially, preferably completely, surrounds the multiple tube elements in the circumferential direction and, in particular, flows around them. The heat exchange medium is formed, for example, as a fluid flowing around the tube element, such as pure water, an aqueous solution, a water-glycol mixture or brine. For this purpose, the housing can have an inlet and an outlet, which are preferably arranged penetrating the housing to the outside of the recovery device.

During operation of the recovery device, the moist exhaust air containing particles is introduced into the housing via the entrance and flows in flow direction through the cleaning unit or past the cleaning unit, through one of the tube elements and exits the housing via the exit. The moist exhaust air has a residual moisture content of 30% to 50% and a temperature of 100° C. to 140° C., for example. Furthermore, the moist exhaust air contains fibers due to upstream drying of drying material, for example clothing, whereby drying is preferably carried out in an industrial dryer. Due to the transfer of heat from the moist exhaust air to the heat exchange medium, the temperature of the exhaust air decreases and at least some of the moisture in the exhaust air condenses inside the tube element. This causes condensate to form inside the tube element, which separates at least a portion of the fibers from the exhaust air or causes the fibers to adhere to the tube element. The condensate with the fibers can be discharged from the housing actively, e.g. by means of a conveyor unit, or passively, e.g. by means of a slope. The drained condensate with the fibers can, for example, be drained or recovered by means of a collection unit arranged in and/or below the usage level of the recovery device, e.g. a gutter or a drain, and then fed back into the building and reused.

As the drying process of the exhaust air progresses, fibers that are already dry are deposited inside the tube element and/or the amount of condensate is no longer sufficient to completely remove the deposited fibers from the tube element. The cleaning unit is designed to remove the preferably already dry fibers deposited inside the tube element.

The cleaning unit is preferably arranged in the direction of flow of the moist exhaust air between the entrance of the housing and the tube element inside the housing. Furthermore, the cleaning unit can be designed to discharge a fluid medium, such as compressed air or water, into the housing. The housing can also have a maintenance opening. This is preferably located in the area of the cleaning unit, making the cleaning unit quickly and easily accessible in the extremely rare event of a malfunction or maintenance.

The cleaning unit preferably has at least one discharge port for discharging a fluid medium, in particular compressed air or water. The discharge port can generally be arranged in a fixed position and is preferably aligned in the direction of flow of the moist exhaust air. According to an advantageous further development of the invention, however, it is provided that the cleaning unit has at least one discharge port rotatable about the longitudinal axis of the housing for discharging a fluid medium, in particular compressed air or water, whereby the tube elements can be cleaned particularly reliably.

The discharge port is generally understood to be an opening in the cleaning unit through which the fluid medium can be discharged. The discharge port can be formed in such a way that the fluid medium is sprayed into the moist, fiber-containing exhaust air. Furthermore, the discharge port can have an outwardly increasing diameter and/or be conical in shape. In addition, the discharge port is particularly preferably formed as a nozzle, so that the fluid medium is discharged under pressure, in particular a pressure of 1 to 8 bar, preferably 2-6 bar, particularly preferably 2-5 bar, into the moist, fiber-containing exhaust air and/or directed onto the tube element(s). The nozzle or discharge port can also be formed as a slot in the surface of the cleaning unit. Rotation of the discharge port about the longitudinal axis of the housing is understood in particular to mean movement along a path of movement at a constant distance from the longitudinal axis of the housing and/or along a circular path with the longitudinal axis at the center. Preferably, the path of movement runs within a plane of movement arranged perpendicular to the longitudinal axis of the housing. In principle, however, the path of movement can be formed in any way, for example elliptically.

It is particularly preferred that the cleaning unit has at least two discharge ports, each arranged on a discharge element. Alternatively, it is preferred that a single discharge element has several discharge ports distributed over its surface. The discharge element or elements are basically formed for the arrangement and/or alignment of the discharge ports and/or a supply of the fluid medium to the discharge ports. Each discharge element preferably has at least one discharge port and particularly preferably exactly one discharge port, which is arranged particularly preferably in the region of one end of the discharge element. Alternatively, the discharge element can also have several discharge ports, which are then particularly preferably arranged at the same distance from one another and/or evenly distributed around the circumference of the discharge element. The discharge elements are preferably tubular and/or unbranched.

Particularly preferably, the discharge elements have at least one curvature. Furthermore, the discharge elements can be connected to one another in one piece. Also preferably, the discharge elements of all discharge ports are formed identically to one another and/or are arranged rotationally symmetrically. A design of the discharge element with an outwardly curved and/or ellipsoidal or hemispherical surface on which the discharge ports are arranged, in particular in the form of several slots, is also particularly preferred. Such discharge ports formed as slots can extend anywhere on the surface of the discharge element, for example radially and/or spirally to the axis of rotation of the discharge element.

The cleaning unit can have an active drive unit, such as an electric motor, to rotate the discharge port and, in particular, to rotate the discharge element about the longitudinal axis of the housing. Preferably, however, it is provided that the discharge elements are formed and/or the discharge port or ports are aligned in such a way that the discharge port or ports are rotated about the longitudinal axis of the housing without drive, in particular by the pressure of the emerging fluid medium. For this purpose, the discharge ports are preferably arranged at an angle in the direction of the path of movement on the discharge elements and/or are formed to run curved on the surface.

According to an advantageous embodiment of the invention, it is provided that the at least one discharge element is arranged on a connecting element of the cleaning unit arranged parallel to the longitudinal axis or preferably in the longitudinal axis of the housing, wherein the discharge element and/or the connecting element are mounted rotatable about the longitudinal axis of the housing. The connecting element is used to guide the fluid medium to the discharge element(s). In addition, the connecting element preferably has a cylindrical shape and/or a round cross-section. The fluid medium is preferably fed to the recovery device via a pipe element, which is arranged on the connecting element and can, for example, be connected to a pump unit arranged outside and/or on the housing and/or inside the building on which the recovery device is arranged. Furthermore, the pipe element is arranged to the housing, preferably sealed, for example by means of a sealing element or a weld seam. Particularly preferably, the connecting element and/or the pipe element has bearing elements, for example plain or roller bearings for rotatable mounting of the discharge elements and/or the connecting element.

According to an advantageous further development of the invention, it is provided that numerous tube elements, which are preferably identical to one another and form a tube bundle heat exchanger, are arranged parallel to one another within the housing, each of the tube elements having an entrance opening at one end for supplying the moist exhaust air containing particles and preferably an exit opening for discharging the exhaust air. It is also preferred that all entrance openings are arranged in a common plane. Further preferably, all entrance openings and/or all exit openings of the tube elements are arranged at an equal distance from the entrance and/or exit of the housing. Also preferably, the cross-sectional area of all tube elements is at least 25%, particularly preferably at least 50% and very particularly preferably at least 75% of the cross-sectional area of the housing, so that good passage of the exhaust air through the tube elements is made possible and/or an undesirable build-up of pressure within the recovery device is avoided. The tube bundle heat exchanger preferably has a length of at least 50% in the direction of the longitudinal axis of the housing, particularly preferably at least 60%, most preferably at least 70% in relation to the length of the housing. The housing preferably has a larger diameter in the area of the tube bundle heat exchanger than at the entrance, so that the diameter of the housing particularly preferably increases steadily in the area of the cleaning unit.

The tube elements preferably extend between two sealing elements arranged inside the housing to separate the moist exhaust air from the heat exchange medium, so that the moist exhaust air containing particles can only flow through the tube elements and the heat exchange medium flows completely around the tube elements on their outside.

The entrance openings and/or the exit openings of the tube elements are preferably arranged on the sealing elements. It is particularly preferred that the tube elements are each connected to the sealing element, for example welded. The sealing elements are preferably plate-shaped. The sealing elements are also preferably arranged perpendicular to the longitudinal axis of the housing, Particularly preferably, the diameter of the sealing elements is adapted to the housing, in particular an internal diameter of the housing, in such a way that the sealing elements with the tube elements preferably arranged between the sealing elements can be inserted into the housing during the manufacture of the recovery device. To seal the sealing elements against the housing, they are welded to the housing, for example. The sealing elements are also preferably made of a metallic material. The inlet and outlet of the housing are each arranged in the area of one of the sealing elements in such a way that the heat exchange medium preferably flows around all the tube elements, particularly preferably crossing the direction of flow of the moist exhaust air between the sealing elements. As the moist exhaust air flows through the tube elements and the heat exchange medium flows past the tube elements, the moist exhaust air containing particles and the heat exchange medium are not in contact.

According to an advantageous embodiment of the invention, it is provided that the at least one discharge port of the cleaning unit is aligned and/or movable in such a way that the fluid medium flows towards an area of the entrance openings of the tube elements and impacts at least a proportion of 40%, preferably 60% and particularly preferably 80% in relation to a total area of all entrance openings. The discharge port is preferably aligned in such a way that the fluid medium is discharged in the direction of flow of the moist, fiber-containing exhaust air, for example parallel and/or at an angle of less than 90°, particularly preferably less than 45° and most preferably less than 15° to the longitudinal axis of the housing. This advantageous embodiment of the invention enables a particularly reliable cleaning of several tube elements of a tube bundle heat exchanger, which significantly reduces the risk of failures or malfunctions of the recovery device, even with an increased throughput.

According to a particularly advantageous further development of the invention, it is provided that the recovery device has a control unit connected to at least one sensor element, in particular at least for controlling the cleaning unit. The control unit is preferably formed as a programmable unit, for example as a computer, as a PLC or in the form of an external and/or higher-level control system. Preferably, the recovery device has at least one, particularly preferably several sensor elements for detecting sensor signals, such as the temperature and/or the pressure and/or the moisture content of the moist exhaust air. The sensor element or elements are connected to the control unit for forwarding the captured data. The sensor element(s) are arranged, for example, in front and/or behind the tube element(s) or additionally preferably in the area of the tube element(s) on the housing. The control unit is preferably connected to at least one control means for activating and deactivating the cleaning unit. Preferably, the control unit is formed in such a way that it executes a predeterminable program as a function of sensor signals. The predeterminable program preferably has setting options for a predeterminable limit value described below. Furthermore, the control unit is formed for forwarding the captured data to a receiver, which is particularly preferably arranged at a distance from the recovery device.

The recovery method according to the invention for industrial heat generators and in particular for industrial drying systems for heat recovery from moist exhaust air containing particles can be carried out in particular with the recovery device described above and comprises as process steps a supply of moist, exhaust air contaminated with particles and in particular with fibers via the entrance to several tube elements of the recovery device, a heat exchange between the moist exhaust air and the heat exchange medium tempering and/or flowing around the tube elements and at least temporary cleaning of the tube elements by means of a cleaning unit of the recovery device to remove deposited particles and/or fibers and/or to keep the tube elements free of particles and/or fibers. fibers and/or to keep the tube elements free of particles or fibers. Preferably, the dry exhaust air, which is at least partially separated from particles or fibers, is discharged via the exit of the housing, e.g. into the environment.

In principle, the tube elements can be cleaned in any way, at any time and for any duration. Preferably, however, cleaning is controlled periodically and/or as a function of a predeterminable limit value and/or for a fixed duration and/or after or for a fixed time interval. It is particularly preferred that a moisture content and/or a temperature of the exhaust air is set as a predeterminable limit value. The moisture content and the temperature of the exhaust air are preferably detected by means of the sensor elements described above and are particularly preferably monitored continuously. One and/or two different predeterminable limit values can be provided for the moisture content and the temperature of the exhaust air. The cleaning unit is activated, for example, when the moisture content of the exhaust air falls below a first limit value and/or when the temperature of the exhaust air exceeds a second limit value, as self-cleaning is no longer possible during a textile drying process due to the condensing water when the moisture content falls below a certain level. An end phase of a drying process can also be recognized by the rising temperature, so that this is a good time for cleaning before the recovery device is used again.

It is particularly preferable that heat is initially recovered from the moist exhaust air without cleaning the tube element(s) and, as the drying process progresses and the moisture content of the exhaust air decreases, cleaning is switched on in order to remove fibers that are already dry from the tube element(s) by means of a fluid medium flowing through the respective tube element.

Two embodiments of the recovery device according to the invention and of the recovery method according to the invention are explained in more detail below with reference to the drawings. The figures show in:

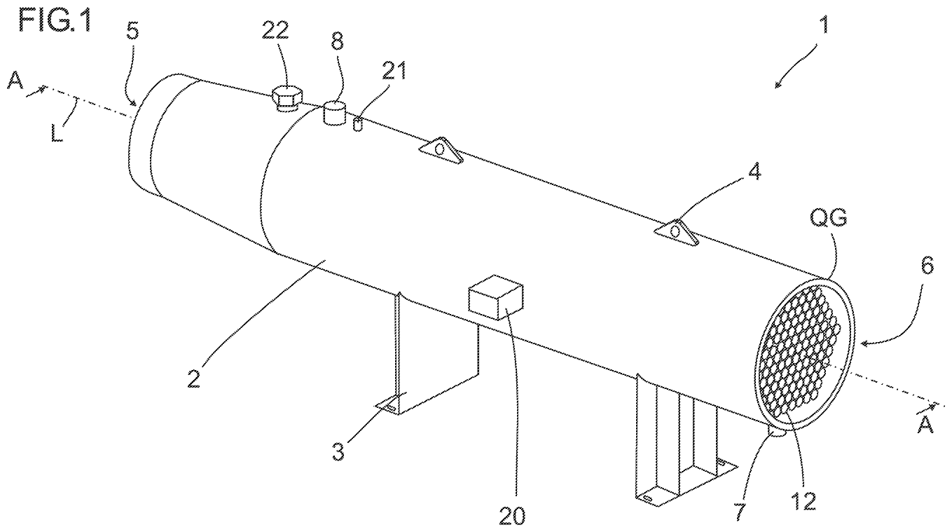

FIG. 1 a schematic view of a recovery device;

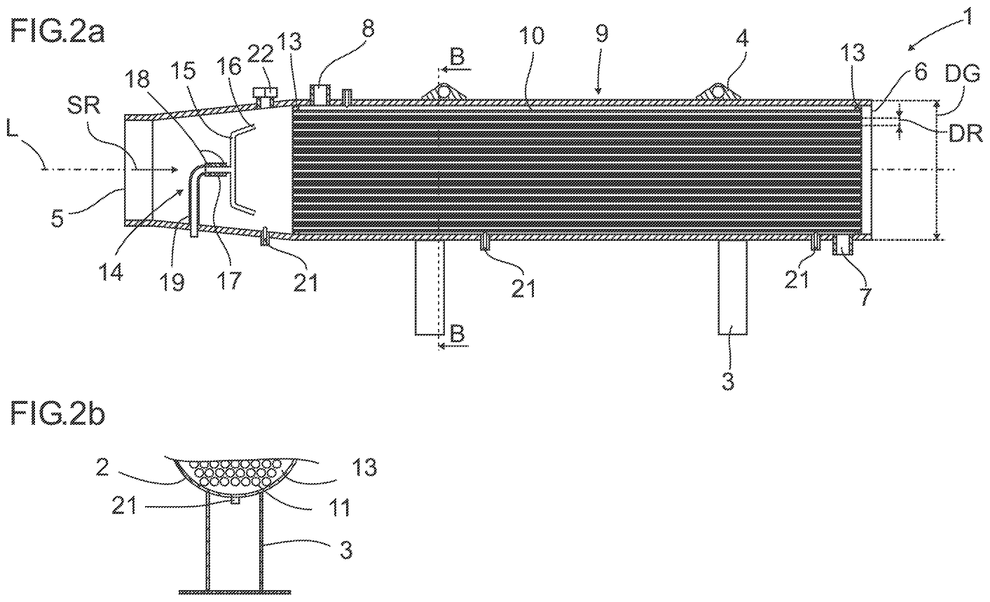

FIG. 2a a schematic longitudinal section along line A-A of the recovery device shown in FIG. 1,

FIG. 2b a schematic sectional view along line B-B of the recovery device shown in FIGS. 1 and 2a, and

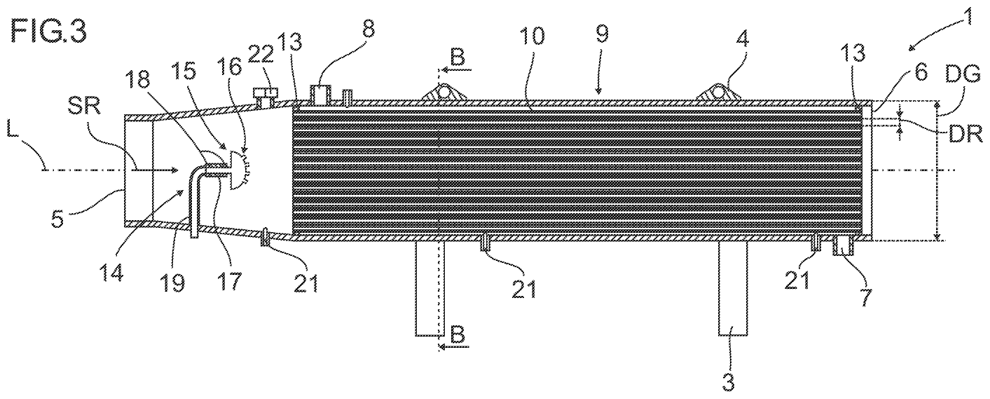

FIG. 3a schematic longitudinal section through a second version of a recovery device with a modified cleaning unit.

FIG. 1 shows an exemplary embodiment of a recovery device 1 with a housing 2. The housing 2 has two support elements 3 for locking the housing 2 on a roof and two holding elements 4 for transporting the housing 2. Furthermore, the housing 2 has an entrance 5 for the supply of moist exhaust air containing fibers and an exit 6 for the removal of the exhaust air. Furthermore, the housing 2 has a circular cross-section QG with a diameter DG extending along a longitudinal axis L of the housing 2 between the entrance 5 and the exit 6.

An inlet 7 and an outlet 8 are arranged on the housing 2 for the passage of a heat exchange medium in the form of a water-glycol mixture.

As shown in FIG. 2a, several tube elements 10 forming a tube bundle heat exchanger 9 are arranged parallel to each other inside the housing 2. The tube elements 10 are identical to each other and are each formed as a tube with a constant diameter DR. Each tube element 10 has an entrance opening 11 and an exit opening 12. The tube elements are arranged between two sealing elements 13 arranged at a distance from one another along the longitudinal axis L of the housing. The entrance openings 11 and the exit openings 12 are each arranged on the sealing elements 13 in a common plane formed by the sealing elements 13. Furthermore, the entrance openings 11 and the exit openings 12 are each arranged at an equal distance from the entrance 5 and the exit 6. The sealing elements 13 separate the heat exchange medium from the fiber-containing, moist exhaust air. The housing 2, the sealing elements 13 and the tube elements 10 are made of a steel material.

A cleaning unit 14 with two discharge ports 16, each arranged on a discharge element 15, is arranged inside the housing 2 in front of the tube elements 10. The discharge elements 15 are connected to each other in one piece and are rotatably mounted on a connecting element 17 in bearing elements 18 about the longitudinal axis L of the housing 2. A fluid medium in the form of compressed air is supplied to the discharge elements 15 and the discharge ports 16 via a pipe element 19 connected to the connecting element 17. Furthermore, a maintenance opening 22 is arranged on the housing 2 in the area of the cleaning unit 14.

In an alternative embodiment, not shown, the cleaning unit 14 can have several discharge ports 16 arranged at a distance from one another along the discharge elements 15.

Furthermore, the recovery device 1 according to FIG. 1 has a control unit 20 and several sensor elements 21 connected to the control unit 20, e.g. for detecting a moisture content and a temperature of the exhaust air. The sensor elements 21 are arranged on the housing 2 (see FIG. 2a).

The recovery device 1 can be used to carry out a recovery method. The recovery device 1 is connected, for example, to an industrial drying system for drying moist textiles and laundry. For this purpose, the recovery device 1 is designed to pass through a volume flow of 9000 l/h. The moist, fiber-containing exhaust air emitted by the drying system is supplied to the recovery device 1 via the entrance 5 of the housing 2. The fiber-containing, moist exhaust air flows in flow direction SR from the entrance 5 past the cleaning unit 14 and into the tube elements 10 via the entrance openings 11. The heat exchange medium flowing via the inlet 7 to the outlet 8 continuously flows around the tube elements 10. In the tube bundle heat exchanger 9, a heat exchange takes place between the fiber-containing, moist exhaust air and the heat exchange medium. The latter has a lower temperature than the fiber-containing, moist exhaust air, so that there is a temperature gradient in the direction of the heat exchange medium. The heat exchange causes the temperature of the fiber-containing, moist exhaust air to drop and condensate forms inside the tube elements 10. The condensate is used to remove a proportion of the fibers contained in the exhaust air from the housing 2, as the condensate flows with the fibers out of the exit 6 of the housing 2. The dry exhaust air, which is largely free of fibers, is discharged from the exit 6 of the housing 2 into the environment.

The sensor elements 21 continuously detect the temperature and the moisture content of the moist exhaust air and send the captured data to the control unit 20. As the drying process progresses, the moisture content of the exhaust air decreases. When the moisture content falls below a limit value that can be predetermined with the control unit 20, the cleaning unit 14 is switched on by the control unit 20. The discharge elements 15 rotate around the longitudinal axis L of the housing 2 due to the compressed air flowing out of the discharge ports 16. The discharge ports 16 are aligned in the direction of the entrance openings 11 of the tube elements 10, so that the compressed air is introduced into all tube elements 10 in conjunction with the rotation of the discharge elements 15. The compressed air flows through the tube elements 10 and removes fibers that are already dry and deposited in the tube elements 10. In addition, the compressed air promotes the transport of the condensate with the fibers in the direction of the exit 6 of the housing 2.

The recovery device 1 enables the energy of the moist and warm exhaust air from the industrial drying system to be recovered for a commercial laundry. By recovering the heat from the exhaust air and, if necessary, reusing the condensate in the laundry, up to approx. 120 KW/b of energy can be recovered, for example. By arranging the cleaning unit 1 upstream of the tube bundle heat exchanger 9 and the associated removal of fibers deposited in the tube elements 10, the risk of malfunctions and failures of the recovery device 1 can be greatly reduced.

A second embodiment of a recovery device 1 shown in FIG. 3 differs only in the design of the cleaning unit 14. Here, the discharge element 15, which is rotatably arranged on the pipe element 19 by means of a bearing element 18, is formed with an outwardly curved surface or as a section of a spherical surface, wherein the discharge ports 16 are formed as slot-shaped nozzles on this curved surface. During operation of the cleaning unit 14, the fluid medium for cleaning, in this case water, although compressed air is also conceivable, is introduced into the interior of the discharge element 15 under pressure and expelled through the discharge ports 15 in the surface in the direction of the entrance openings 11 of the tube elements 10. Due to a radially curved course of the discharge ports 16, which are formed as slot-shaped nozzles, the discharge element 15 rotates automatically. This is also preferably made of stainless steel and/or has a uniform arrangement of the discharge ports 16 on the surface of the discharge element 15, in particular uniformly in relation to its axis of rotation.

### LIST OF REFERENCE SYMBOLS

1 Recovery device
2 Housing
3 Support element
4 Holding element
5 Entrance
6 Exit
7 Inlet
8 Outlet
9 Tube bundle heat exchanger
10 Tube elements
11 Inlet opening
12 Exit opening
13 Sealing element
14 Cleaning unit
15 Discharge element
16 Discharge ports
17 Connecting element
18 Bearing element
19 Pipe element
20 Control unit
21 Sensor element
22 Maintenance opening
L Longitudinal axis of the housing
DG Diameter of the housing
DR Diameter of the tube element
QG Cross-section of the housing
SR Flow direction of the exhaust air

1. Recovery device for industrial heat generators including industrial drying systems for recovering heat from moist exhaust air containing particles, with
a housing extending in a flow direction of the moist exhaust air containing particles from an entrance to an exit,
a plurality of tube elements extending parallel to each other within the housing and
a heat exchange medium for absorbing heat from the moist exhaust air containing particles,
wherein
the moist exhaust air containing particles is directed through the inside of the tube elements and the heat exchange medium flows around the outside of the tube elements and
a cleaning unit for cleaning the inside of the tube elements is arranged upstream of the tube elements in the flow direction of the moist exhaust air containing particles.

2. Recovery device according to claim 1, wherein the cleaning unit has at least one discharge port which is rotatable about a longitudinal axis of the housing for discharging a fluid medium.

3. Recovery device according to claim 1, wherein the cleaning unit comprises at least two discharge ports arranged on an outwardly curved surface of a discharge element.

4. Recovery device according to claim 1, wherein the at least one discharge element is arranged on a connecting element of the cleaning unit arranged parallel to the longitudinal axis or in the longitudinal axis of the housing, wherein the at least one discharge element and/or the connecting element being mounted rotatable about the longitudinal axis of the housing.

5. Recovery device according to claim 1, wherein multiple tube elements which are identical to one another and form a tube bundle heat exchanger are arranged parallel to one another inside the housing, each of the tube elements having an entrance opening at one end for supplying moist exhaust air containing particles, and all the entrance openings being arranged in one plane.

6. Recovery device according to claim 1, wherein the at least one discharge port of the cleaning unit is oriented and/or movable in such a way that the fluid medium is directed towards a region of the entrance openings of the tube elements and impacts on at least a proportion of 40%, or at least 60%, or at least 80% with respect to a total area of all entrance openings.

7. Recovery device according to claim 1, wherein the tube elements extend between two sealing elements arranged inside the housing for separating the moist exhaust air containing particles from the heat exchange medium, so that the moist exhaust air containing particles can only flow through the tube elements and the heat exchange medium flows completely around the tube elements on their outside.

8. Recovery device according to claim 1, comprising a control unit connected to at least one sensor element at least for controlling the cleaning unit.

9. A recovery method for industrial heat generators including industrial drying systems for recovering heat from moist exhaust air containing particles by means of a recovery device, according to claim 1, comprising the steps of
supply of moist, particle-contaminated exhaust air via an entrance to several tube elements of the recovery device,
heat exchange between the moist exhaust air containing particles and a heat exchange medium tempering and/or flowing around the tube elements, and
at least temporary cleaning of the interior of the tube elements using a cleaning unit of the recovery device for removing deposited particles.

10. Recovery method according to claim 9, wherein the cleaning of the tube elements is controlled periodically and/or as a function of a predeterminable limit value.

11. Recovery method according to claim 9, wherein a moisture content and/or a temperature of the moist exhaust air containing particles is set as a predeterminable limit value.

12. Recovery method according to claim 9, wherein heat is initially recovered from the moist exhaust air containing particles without cleaning the tube elements and, as the drying process progresses and the moisture content of the moist exhaust air containing particles decreases as a result, cleaning is switched on in order to remove already dry particles from the tube elements by a fluid medium flowing through the respective tube elements.
